(19) United States
(12) Patent Application Publication
(10) Pub. No.: US 2014/0183316 A1
(43) Pub. Date: Jul. 3, 2014

(54) MOUNTING APPARATUS FOR DATA STORAGE DEVICE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: XIANG-KUN ZENG, Shenzhen (CN); ER-WEI LU, Shenzhen (CN); ZHI-QIANG ZUO, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/011,931

(22) Filed: Aug. 28, 2013

(30) Foreign Application Priority Data
Dec. 27, 2012 (CN) 2012105769590

(51) Int. Cl. G06F 1/18

(52) U.S. Cl. CPC G06F 1/187
USPC 248/316.7

(57) ABSTRACT

A mounting apparatus includes a bracket and two latching structures. The bracket includes a base and two clipping structures located on the base. The base defines a receiving space configured to receive a data storage device. Each of the two clipping structures includes two guiding rails and two clipping pieces respectively connected to the two guiding rails. The two latching structures are configured to secure the data storage device to the bracket without screws, and each of the two latching structures includes a neck portion and a head portion connected to the neck portion. Each head portions are held between the two guiding rails of the two clipping structures, and the neck portion is clipped between the two clipping pieces, to prevent the data storage device from disengaging from the receiving space.

### BACKGROUND

1. Technical Field

The present disclosure relates to mounting apparatuses, and more particularly to a mounting apparatus with a bracket.

2. Description of Related Art

Various data storage devices are installed in computers for communication and handling of data. Such devices include, hard disk drives, floppy disk drives, and CD-ROM drives, for example. A data storage device is attached to a bracket with screws or bolts, which makes assembling and disassembling of the data storage device from the bracket very inconvenient. Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a mounting apparatus and a storage device in accordance with an embodiment.

FIG. 2 is an enlarged view of a circled portion II of FIG. 1.

FIG. 3 is an enlarged view of a circled portion III of FIG. 1.

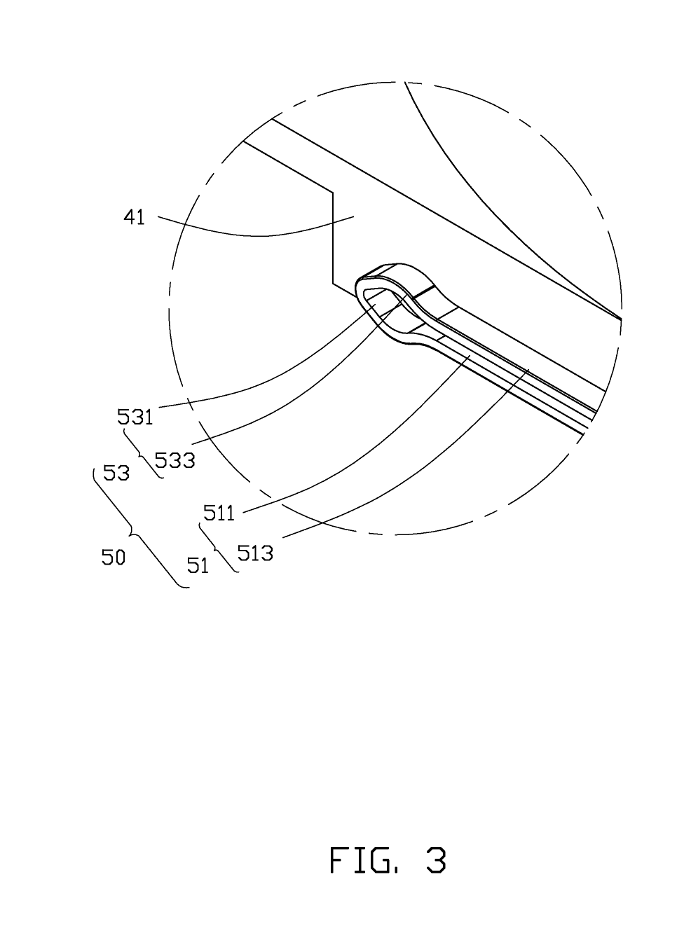

FIG. 4 is a partially assembled view of FIG. 1.

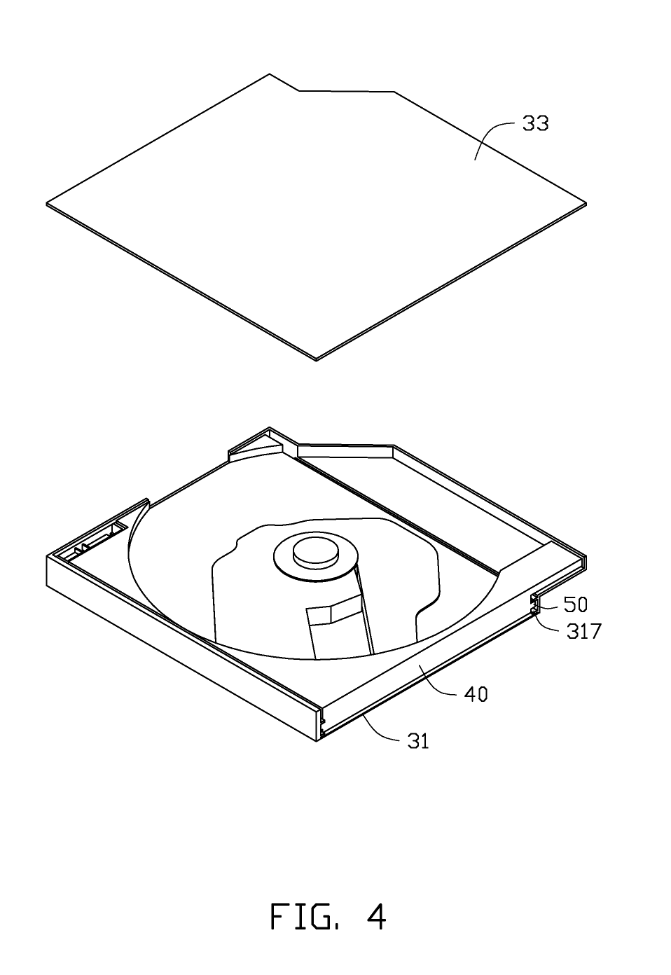

FIG. 5 is an assembled view of FIG. 1.

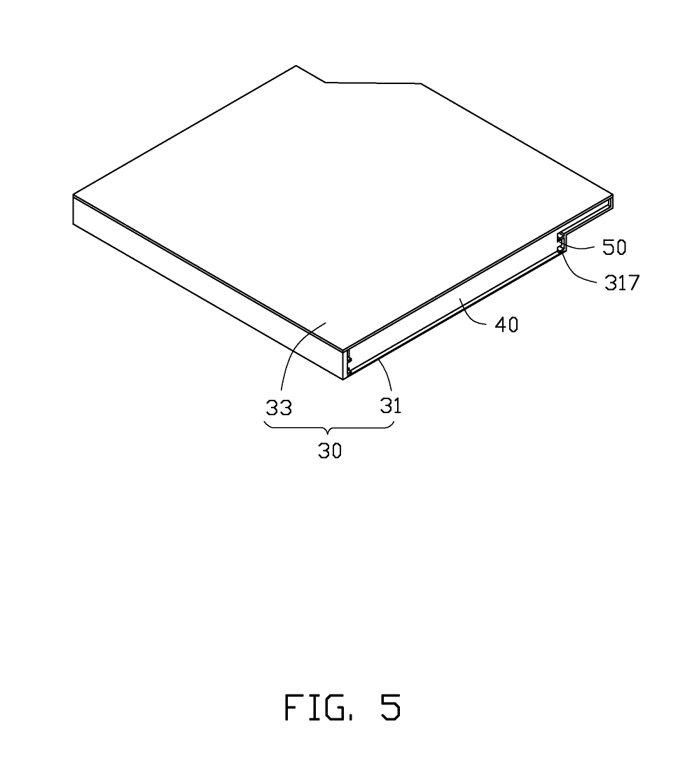

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

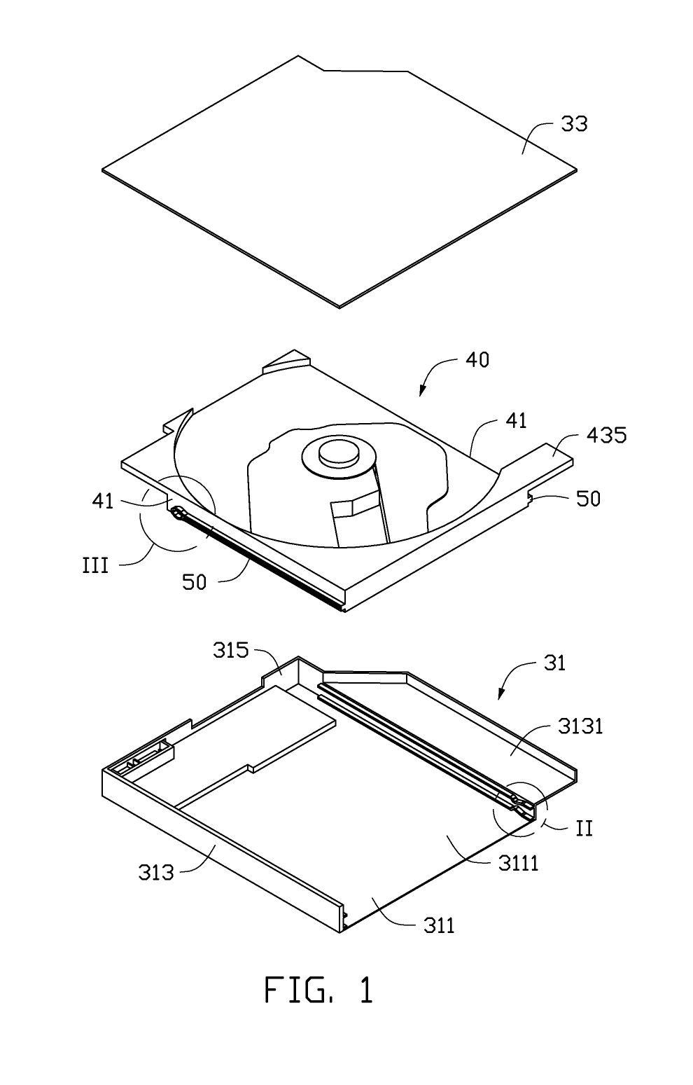

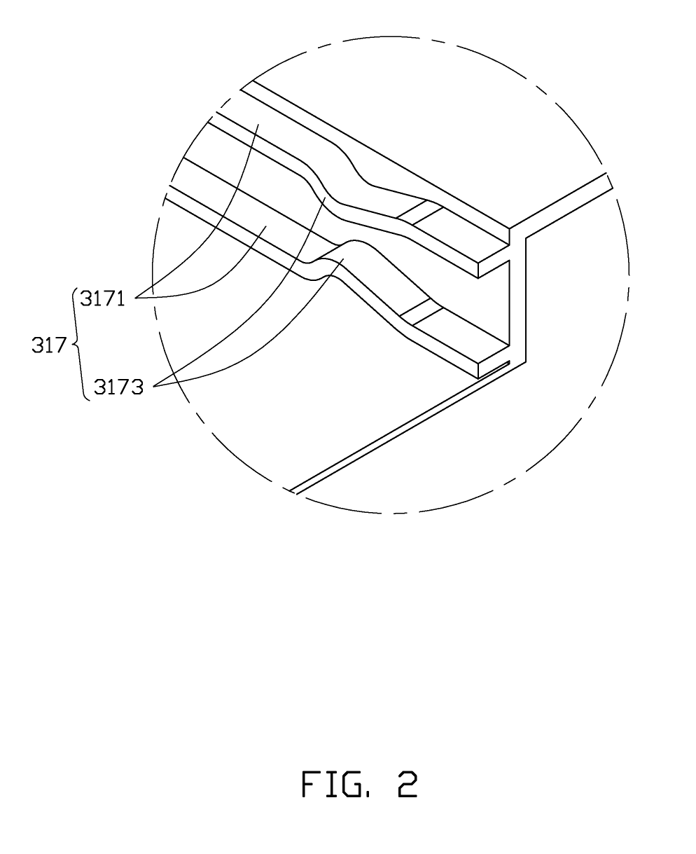

Referring to FIGS. 1-2, a mounting apparatus is configured for securing a data storage device 40. The data storage device 40 can be a hard disk drive, a floppy disk drive, a compact disc read-only memory drive, and so on. The mounting apparatus includes a bracket 30 and two latching structures 50. The latching structures 50 are located on the data storage device 40.

The bracket 30 includes a base 31 and a cover 33. The cover 33 covers the base 31. The base 31 includes a bottom plate 311, two side plates 313, and a rear plate 315. The two side plates 313 extend from opposite sides of the bottom plate 311, respectively. The rear plate 315 extends from a rear edge of the bottom plate 311. The bottom plate 311, the two side plates 313, and the rear plate 315 cooperatively define a receiving space 3111 for receiving the data storage device 40. In one embodiment, the two side plates 313 are substantially parallel to each other and substantially perpendicular to the bottom plate 311, and the rear plate 315 is perpendicularly connected to the two side plates 313 and the bottom plate 311. A supporting flange 3131 extends from one of the two side plates 313 for supporting the data storage device 40.

A clipping structure 317 is located on an inner side of each of the two side plates 313. Each clipping structure 317 includes two guiding rails 3171 and two clipping pieces 3173. The two guiding rails 3171 both run along the inner side of the side plate 313, and the two clipping pieces 3173 are both arc-shaped. The two clipping pieces 3173 extend from the two guiding rails 3171, respectively. In one embodiment, the two guiding rails 3171 are parallel to each other and are parallel to the bottom plate 311. A minimum distance is defined between the two clipping pieces 3173, and the minimum distance is smaller than a distance between the two guiding rails 3171.

The data storage device 40 includes two sidewalls 41 and an actuating block 435 extending from one of the two sidewalls 41. The two sidewalls 41 are parallel to each other. The two latching structures 50 are located on the two sidewalls 41, respectively. Each latching structure 50 includes a neck portion 51 and a head portion 53. The head portion 53 is connected to the neck portion 51. The neck portion 51 includes a first latching piece 511 and a second latching piece 513 extending from the sidewall 41. The first latching piece 511 is parallel to the second latching piece 513, and a distance between the first latching piece 511 and the second latching piece 513 is slightly greater than the minimum distance of the two clipping pieces 3173. The head portion 53 includes a first resisting piece 531 and a second resisting piece 533. The second resisting piece 533 is connected to the first resisting piece 531. The first resisting piece 531 and the second resisting piece 533 are both arc-shaped and cooperatively form an oval shape. A maximum distance between the first resisting piece 531 and the second resisting piece 533 is slightly smaller than the distance between the two guiding rails 3171, and is greater than the minimum distance between the two clipping pieces 3173.

In assembly, the head portions 53 of the data storage device 40 are aligned with the clipping structures 317 of the base 31, respectively. The data storage device 40 is pushed along a first direction, until the head portion 53 of each latching structure 50 passes over the two clipping pieces 3173 to be held between the two guiding rails 3171. The first resisting piece 531 and the second resisting piece 533 abut the two guiding rails 3171, respectively. The two clipping pieces 3173 hold the first latching piece 511 and the second latching piece 513, respectively, to prevent the data storage device 40 from moving along a second direction opposite to the first direction.

In disassembly of the data storage device 40, the data storage device 40 is pulled along the second direction, until the head portion 53 is resiliently deformable to disengage from the corresponding clipping pieces 3173.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A mounting apparatus comprising:
a bracket comprising a bottom plate, two side plates located on the bottom plate, and a rear plate located on the bottom plate; two guiding rails and two clipping pieces being located on each of the two side plates, and each of the two clipping pieces extending from each of the two guiding rails; and the bottom plate, the two side plates and the rear plate are configured to cooperatively receive a data storage device; and
two latching structures configured to secure the data storage device to the bracket, each of the two latching structures comprises a neck portion and a head portion connected to the neck portion; each head portion being engaged between the two guiding rails of each of the two side plates, and the neck portion being clipped between the two clipping pieces of each of the two side plates, to prevent the data storage device from disengaging from the bracket; and the head portion is resiliently deformable to disengage from the two clipping pieces.

2. The mounting apparatus of claim 1, wherein the head portion comprises a first resisting piece and a second resisting piece connected to the first resisting piece, and each of the first resisting piece and the second resisting piece abuts each of the two guiding rails of each of the two side plates.

3. The mounting apparatus of claim 2, wherein the two guiding rails are parallel to each other and parallel to the bottom plate.

4. The mounting apparatus of claim 3, wherein a maximum distance is defined between the first resisting piece and the second resisting piece; and a distance between the two guiding rails is slightly greater than the maximum distance.

5. The mounting apparatus of claim 4, wherein the neck portion comprises a first latching piece and a second latching piece; and the first latching piece and the second latching piece are parallel to each other.

6. The mounting apparatus of claim 5, wherein a minimum distance is defined between the two clipping piece; and the minimum distance is slightly smaller than a distance between the first latching piece and the second latching piece.

7. The mounting apparatus of claim 6, wherein the maximum distance is greater than the minimum distance.

8. The mounting apparatus of claim 1, wherein each of the two clipping pieces is substantially arc-shaped.

9. The mounting apparatus of claim 5, wherein each of the two guiding rails is elongated, and each of the first latching piece and the second latching piece is elongated.

10. A mounting apparatus comprising:
a bracket comprising a base, the base defining a receiving space configured to receive a data storage device and comprising two clipping structures; each of the two clipping structures comprising two guiding rails and two clipping pieces extending from the two guiding rails, respectively; and
two latching structures configured to secure the data storage device to the bracket, each of the two latching structures comprising a neck portion and a head portion connected to the neck portion; each head portion being engaged between the two guiding rails of each of the two clipping structures, and the neck portion being clipped between the two clipping piece of each of the two clipping structures, to prevent the data storage device from disengaging from the receiving space; and the head portion is resiliently deformable to disengage from the two clipping pieces.

11. The mounting apparatus of claim 10, wherein the base further comprising a bottom plate and two side plates located on the bottom plate, and each of the two clipping structures are located on each of the two side plates.

12. The mounting apparatus of claim 11, wherein the two guiding rails of each of the two clipping structures extend from an inner side of each of the two side plates.

13. The mounting apparatus of claim 11, wherein the head portion comprises a first resisting piece and a second resisting piece connected to the first resisting piece, and each of the first resisting piece and the second resisting piece abuts each of the two guiding rails of each of the two side plates.

14. The mounting apparatus of claim 13, wherein the two guiding rails are parallel to each other and parallel to the bottom plate.

15. The mounting apparatus of claim 14, wherein a maximum distance is defined between the first resisting piece and the second resisting piece; and a distance between the two guiding rails is slightly greater than the maximum distance.

16. The mounting apparatus of claim 15, wherein the neck portion comprises a first latching piece and a second latching piece; and the first latching piece and the second latching piece are parallel to each other.

17. The mounting apparatus of claim 16, wherein a minimum distance is defined between the two clipping piece; and the minimum distance is slightly smaller than a distance between the first latching piece and the second latching piece.

18. The mounting apparatus of claim 17, wherein the maximum distance is greater than the minimum distance.

19. The mounting apparatus of claim 10, wherein each of the two clipping piece is substantially arc-shaped.

20. The mounting apparatus of claim 16, wherein each of the two guiding rails is elongated, and each of the first latching piece and the second latching piece is elongated.
